(19) United States
(12) Patent Application Publication
(10) Pub. No.: US 2002/0010716 A1
(43) Pub. Date: Jan. 24, 2002

(54) System and method for dynamically publishing XML-compliant documents

(76) Inventors: Alan F. McCartney, Nederland, CO (US); Matthew S. Funk, Superior, CO (US); Julien Mercay, Los Altos, CA (US); Herve Marmy, Esravayer-le-lac (CH)

Correspondence Address: William J. Kubida, Esq., Hogan & Hartson, LLP, Suite 1500, 1200 17th Street, Denver, CO, 80202, US

(21) Appl. No.: 09/772,038

(22) Filed: Jan. 29, 2001

Related U.S. Application Data
(60) Provisional application No. 60/184,812, filed on Feb. 24, 2000.

(51) Int. Cl. G06F 17/21

(52) U.S. Cl. 707/517

(57) ABSTRACT

A system dynamically generates web pages that are optimized for a client's capabilities. In one embodiment, a client capability matrix is created. The matrix distinguishes between clients based on one or more parameters, such as browser type, browser version, available data transfer rate, display capabilities, and terminal device specifications. Additionally, a plurality of XSL stylesheets are created. Each type of client is associated with one XSL stylesheet, but one XSL stylesheet may be associated with one or more type of client. When a client requests a document from the system, the system determines the client capabilities and selects an associated XSL stylesheet. This selected stylesheet is then merged with an XML content document that is associated with the requested document. The merged document is then ransmitted to the client as an XML compliant document, such as an XHTML document.

### CROSS REFERENCE TO RELATED INVENTION

The present application claims the benefit of U.S. Provisional Patent Application Serial No. 60/184,182, filed Feb. 24, 2000.

### FIELD OF THE INVENTION

The invention relates generally to dynamically publishing eXtensible Markup Language (XML) compliant documents for different clients, such as web browsers. More specifically, this invention relates to dynamically publishing XML-compliant documents using an eXtensible Stylesheet Language (XSL) stylesheet that is dynamically selected by the system based on the capabilities of the client requesting the information.

### BACKGROUND OF THE INVENTION

Web browsers, or browsers, are commonly used to retrieve information from the World Wide Web (“WWW”). A browser is a software application used to locate and display Web pages. Popular browsers include Netscape Navigator, Microsoft Internet Explorer, and HotJava™. HotJava is a trademark or registered trademark of Sun Microsystems, Inc., in the United States and other countries. Generally, web browsers are software applications that use a Hypertext Transfer Protocol (HTTP) link to communicate graphics and text with network-connected web server software. Some variation exists in functionality between various browser products. Furthermore, there are different versions of each of these browsers and browsers are designed for different operating systems. Additionally, there are plug-ins that can be added to a browser, which cause further differentiation between the functions performed by different browsers.

In addition to different types and versions of software on a device, there are different performance characteristics for the devices themselves. For example, palm-sized devices, cellular phones, copy and fax machines, and household appliances, referred to collectively as network appliances, are now able to receive information via the Internet. The functionality available to these network appliances is limited by many factors including processing capability, resolution, color depth and screen size. Additionally, the browsers available for many network appliances, such as portable devices, do not support commonly used web features, such as JavaScript™ scripts. JavaScipt is a trademark or registered trademark of Sun Microsystems, Inc., in the United States and other countries

Another constraint on the system is the data transfer rate available to a requesting device, referred to hereinafter as a client. A client connecting to a network, such as the Internet, over a T-1 connection may be able to receive information at a rate of 1.544 Mbits per second, while a client connecting to the same network over a high-speed dial-up connection is limited to a transfer rate of 56 Kilobits per second. For purposes of this application, the browser type, browser version, available data transfer rate, display capabilities, and terminal device specifications are referred to collectively as client capabilities.

Currently, a web site developer is responsible for determining various web site parameters. For example, the web site developer must determine which functions to include in a web page, which implicitly determines which browsers may effectively use the web page. If a web site developer creates a web site optimized for clients with extensive client capabilities, then clients with minimal client capabilities will not be able to access the content. On the other hand, if the developer creates a web site optimized for clients with minimal client capabilities, many of the powerful and/or entertaining functions available to clients with extensive client capabilities are not used.

To optimize the web site for clients having different client capabilities, the web site developer may create a plurality of web pages to present the same content, each optimized for different client capabilities. These pages can be served based on information received about the client capabilities of a requesting client. However, maintaining a plurality of different web pages that present the same content may be time consuming. Furthermore, creating a plurality of web pages that are optimized for different, constantly evolving client capabilities can be difficult. These problems are compounded when a web site developer does not know how to optimize pages for clients having different client capabilities. These and other drawbacks exist with other systems.

### SUMMARY OF THE INVENTION

According to one embodiment of the invention, a system dynamically generates web pages using XML content documents and XSL stylesheets that are optimized for a client's capabilities. In one embodiment, an XML-compliant document is dynamically published when a system in accordance with the present invention receives a request for a document from a client. The system determines a set of client capabilities and selects an XSL stylesheet based on the set of client capabilities. Additionally, the system selects an XML content document based on the requested document. The system then merges the selected XML content document and the selected XSL stylesheet to dynamically publish an XML-compliant document.

In one embodiment, a client capability matrix is created. The matrix distinguishes between clients based on one or more parameters, such as browser type, browser version, available data transfer rate, display capabilities, and terminal device specifications. Additionally, a plurality of XSL stylesheets are created. Each type of client is associated with one XSL stylesheet, but one XSL stylesheet may be associated with one or more type of client. When a client requests a document from the system, the system determines the client capabilities and selects an associated XSL stylesheet. This selected XSL stylesheet is then merged with an XML content document that is associated with the requested document. The merged document is then transmitted to the client as an XML-compliant document, such as an XHTML document.

According to another embodiment, the system may allow XSL stylesheets and XML compliant documents to be created and maintained independently. In a preferred embodiment, the system may include administrative accounts and author accounts. The administrator accounts may allow a user to create, delete and modify XSL stylesheets and author accounts. Additionally, the administrator accounts may allow a user to associate a stylesheet with a type of client. The author accounts may allow a user to create, delete and modify XML compliant documents through a graphical user interface (GUI), such as an XHTML form. A form may be transmitted by the system in response to a valid author log-in.

Other features and advantages of the invention will be apparent to one of ordinary skill in the art upon reviewing the detailed description of the invention.

### BRIEF DESCRIPTION OF THE DRAWINGS

FIG. 1 is schematic diagram of a network in accordance with the present invention.

FIG. 2 is a schematic diagram of the formation of XHTML documents in accordance with the prior art.

FIG. 3 is a schematic diagram of the formation of XHTML documents in accordance with the present invention.

FIG. 4 is a high level flow chart of an XSL mapping function.

FIG. 5 is a high-level flow chart of dynamically publishing a document.

FIG. 6 is a detailed flow chart of dynamically publishing a document.

FIG. 7 is a graphical user interface for an author client.

### DETAILED DESCRIPTION

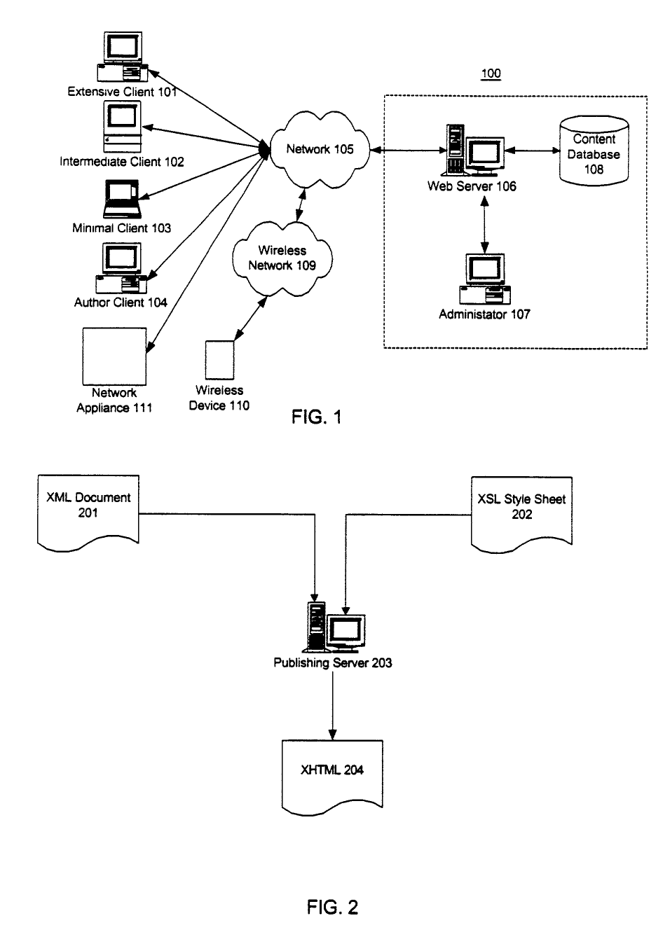

FIG. 1 is schematic diagram of a network in accordance with the present invention. According to one embodiment of the invention, a system 100 is provided for transmitting optimized documents across a network 105 to a plurality of clients 101-104 having different capabilities. In a preferred embodiment, network 105 comprises the Internet.

A web server 106 receives HTTP requests from clients 101-104 and, in response to these requests, retrieves content from content database 108. Web server 106 determines which one of a plurality of XSL stylesheets to use based on at least one client capability. After retrieving the content and the XSL stylesheets, web server 106 merges the content and XSL stylesheet into one or more documents, such as one or more XHTML documents, that may be transmitted to one or more of the plurality of clients 101-104.

Administrator 107 is used to establish and update the XSL stylesheets that are mapped to the various client capabilities. Additionally, administrator 107 is used to establish and update what content is to be retrieved based on the received request. Administrator 107 may also be used to control web server 106 and content database 108 in other ways as explained in greater detail below.

FIG. 2 is a schematic diagram of the formation of XHTML document 204 in accordance with the prior art. XML document 201 is a content document. XHTML is an XML compliant markup language that is similar to HTML and readable by HTML browsers. XML document 201, like an HTML document, uses tags to contain information about the information, or metainformation. However, unlike an HTML document, XML document 201 does not use tags to control the presentation of information on a client output device. XML document 201 uses tags only to indicate the type of information that is contained between the tags.

XSL stylesheet 202 provides the presentation information that XML document 201 does not provide. Publishing server 203 merges XML document 201 and XSL document 202 to produce XHTML document 204. XHTML document 204 integrates the presentation information provided by XSL document 202 and the content information provided by XML document 201.

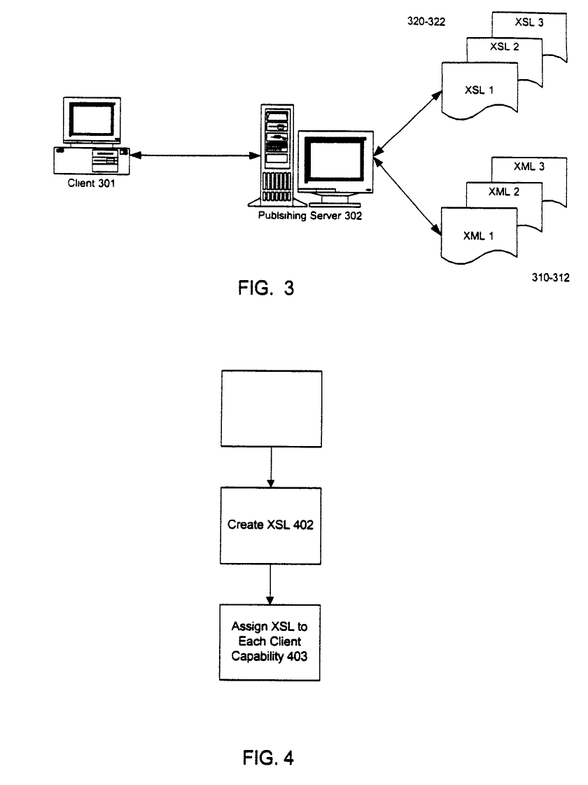

FIG. 3 is a schematic diagram of the formation of XHTML documents in accordance with the present invention. Client 301 submits a request to publishing server 302. Publishing server 302 may be collocated with web server 106. Additionally, publishing server software may reside on the same physical server as the web server software. As depicted in FIG. 1, the request may be submitted across a network such as the Internet.

In a preferred embodiment, the request includes information relating to at least one client capability. For example, the request may include information relating to the type of browser type and browser version that a client is using to render the requested content. Additionally, the client capability information may indicate whether the client has additional plug-ins and/or programs, such as multimedia plug-in Macromedia Flash and document exchange application Adobe Acrobat. This client capability information may be provided in a packet header or a packet body of a TCP packet transmitted across the Internet, or stored as a cookie on the client device, for example.

In addition to distinguishing based on browser type, browser version, and client plug-ins, other parameters may be used to indicate client capabilities. For example, different client categories may be established for handheld devices, dial-up connected computers, and high-speed networked computers. Other categories may be established using administrator 107.

Furthermore, various client capabilities may be communicated to the client individually instead of or in addition to being communicated as part of a client category. For example, the following capabilities may be communicated to publishing server 302: a processor speed of the client's processor; a supported language capability that identifies the objects, methods and properties that the client can use; a comprehended language capability that identifies in which language a user wants to receive the content; an amount of bandwidth available to the client; and physical parameter capability identifying a screen size, a screen resolution capability, and a screen color capability. Some or all of this information may be maintained on an Internet service provider or application service provider server (not shown) that serves as an intermediary between client 301 and publishing server 302. In one embodiment, a profile server as disclosed in U.S. patent application Ser. No. 09/314,375 entitled EXTERNAL DATA STORE LINK FOR A PROFILE SERVER, filed May 19, 1999, serves as an intermediary.

Based on the at least one client capability received, publishing server 302 selects one of the plurality of XSL stylesheets 320-322. For example, based on the fact that the client is using an iBrowser Plus client, publishing server 302 may select an XSL stylesheet 320 that is optimized for iBrowser Plus clients. Stylesheet 320 may include only small graphics, no dropdown menus, no audio content, but allow secure communications in accordance with the browser's capabilities. XSL stylesheet 321 may be an Internet Explorer 4.0 and above browser, meaning that it can support ActiveX controls, Cascading Stylesheet (CSS) positioning, data binding, and all features supported by 3.0 browsers. XSL stylesheet 322 may be a primitive stylesheet that efficiently presents information to a robot or search engine. Other stylesheets may be used to accommodate as many different client capabilities as an administrator determines is appropriate for the system.

Once a stylesheet has been selected, the content is retrieved in the form of XML documents 310-312. XML documents 310-312 may be retrieved from a content database 108 or from another data store. This content may be static, such as a bus schedule, or generated, such as a personalized bus schedule. Additionally, the content may be a combination of static and generated content, such as a personalized bus schedule (generated) and a disclaimer that the bus schedules are only accurate to within 5 minutes (static). Generated content may be generated using conventional programming techniques for generating content, such as Java Script Applets.

Once both the requested XML document and the requested XSL stylesheet have been detected and retrieved, publishing server 302 processes the XML and XSL into an output that can be delivered to and rendered by the client. In one embodiment, the output is XHTML 1.0, however it is anticipated that any XML-compliant output may be used.

FIG. 4 is a high-level flow chart of an XSL mapping function. This mapping function may be implemented using administrator 107 of FIG. 1. In one embodiment, the XSL mapping function may use a client capability table. At step 401, the client capability table is created. An administrator may use administrator 107 to create a record for each client capability set to which a stylesheet is matched. For example, a separate record may be created for iBrowser, iBrowser Plus, all Mozilla versions, Scooter, Internet Explorer 4.0, Internet Explorer 5.0, and all Navigator versions.

At step 402, one or more XSL stylesheets may be created. In a preferred embodiment, a separate XSL stylesheet is created for each client capability set that will access information from the system. For example, if a system is intended to support handheld devices, an XSL stylesheet is preferably created that optimizes output for handheld devices. Preferably, a default XSL stylesheet is created that is at least viewable for all possible client capability sets, even if the XSL stylesheet is not optimized. For example, if an XSL stylesheet optimized for handheld devices is not developed, a generic XSL stylesheet for outputting requested information as a text file may be created.

At step 403, each record is mapped to one XSL stylesheet. In a preferred embodiment, each record can only be mapped to one stylesheet, but two or more records may be mapped to the same XSL stylesheet. For example, if an administrator has not created an XSL stylesheet that optimizes Internet Explorer 5.0, the 5.0 record may be mapped to a 4.0 record until a new XSL stylesheet is developed.

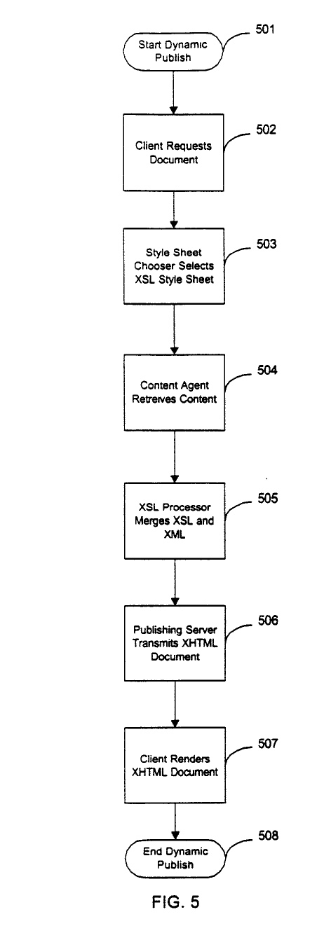

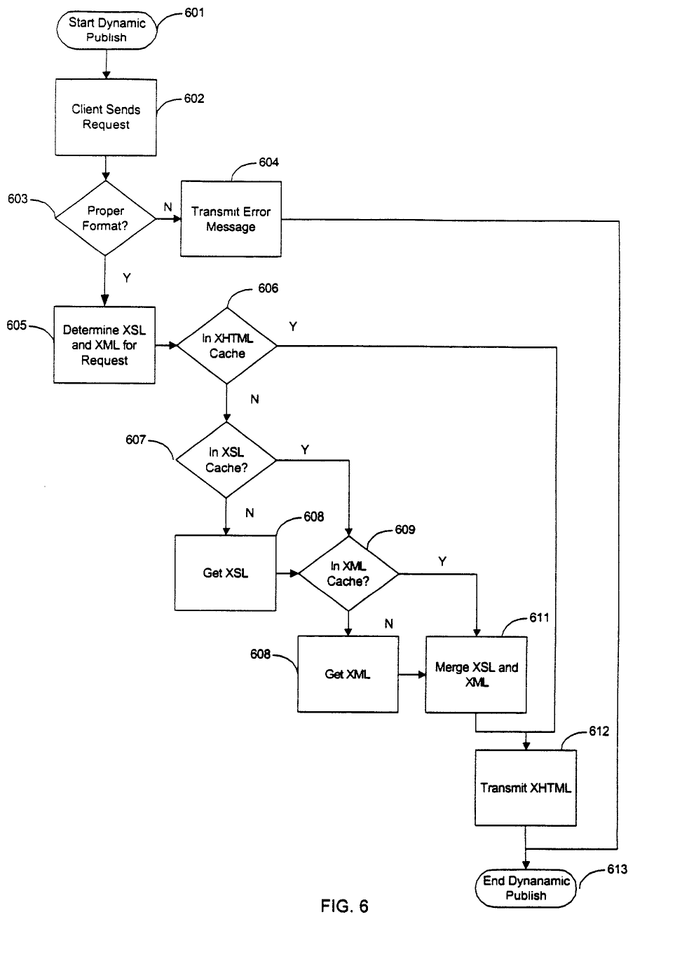

FIG. 5 is a high level flow chart showing steps involved in dynamically publishing a document. The dynamic publishing process starts at step 501. For example, a user may select a hyperlink. At step 502, the client submits a request to the system, such as by transmitting an HTTP request across network 105. At step 503, a stylesheet selector determines a set of client capabilities and selects an XSL stylesheet based on the set of client capabilities. A content agent selects an XML content document based on the requested document at step 504. At step 505, an XSL processor then merges the selected XML content document and the selected XSL stylesheet. A publishing server then publishes an XML compliant document, such as an XHTML document, at step 506. At step 507, the client renders the XML compliant document. The dynamic publish process terminates at step 508. One embodiment of this process is described in greater detail below in relation to FIG. 6.

FIG. 6 is a detailed flow chart of dynamically publishing a document. This flow chart includes a caching analysis that is performed by a preferred embodiment of the invention. Because there may be an extensive number of XSL stylesheets and an extensive number of XML documents, a cache may be used to expedite transmission of recently requested information. This cache may be maintained on web server 106, content database 108 (both shown in FIG. 1), publishing server 302 (FIG. 3), or other data store. The size of the cache may be established via administrator 107 (FIG. 1) or a client (not shown).

The dynamic publishing process starts at step 601. For example, a user clicking on an icon, hyperlink, or other control on a web page may initiate the process. At step 602, the client sends a request to the system. The system determines whether the request is proper at step 603. For example, the system may determine whether the requested information exists on the system, whether the client has access to the requested information, or other determine whether other criteria has been satisfied. If the request is not proper, an error message is transmitted to the user at step 604 and the dynamic publish process is terminated at step 613.

At step 605, the system determines whether the XSL and XML documents that correspond to the request currently reside in cache. As explained above, the XSL sheet is selected based on at least one client capability communicated with the request. The XML document may be a static document, a generated document, or a hybrid document as described above. At step 606, the system may establish whether a corresponding XHTML document is retained in cache that was generated based on the corresponding XSL and XML documents. For example, if step 605 determines that XSL stylesheet “A” and XML document “F” correspond to the requested information, the system may determine whether the cache contains a corresponding XHTML document that was generated from the merging of XSL stylesheet “A” and XML document “F.”

If a corresponding XHTML document exists in cache, the system proceeds to step 612. If there is no corresponding XHTML document currently in cache, the system proceeds to step 607. At step 607, the system determines whether the corresponding XSL stylesheet exists in cache. Using the above example, if an XHTML document does not exist in cache that was generated from the merging of XSL stylesheet “A” and XML document “F,” the system may then determine whether XSL stylesheet “A” exists in cache.

If the corresponding XSL stylesheet is in cache, the cached copy is used and the system proceeds to step 609. If the corresponding XSL stylesheet is not in cache, the XSL stylesheet is retrieved from an associated data store and the system proceeds to step 609. A retrieved XSL stylesheet is maintained in the cache and may cause one or more cached XSL stylesheets to be expunged from the cache. At step 609, the system determines whether the corresponding XML document exists in cache. Using the above example, if an XHTML document does not exist in cache that was generated from the merging of XSL stylesheet “A” and XML document “F,” the system may then determine whether XML document “F” exists in cache.

If the corresponding XML document is in cache, the cached copy is used and the system proceeds to step 611. If the corresponding XML document is not in cache, the XML document is retrieved from an associated data store and the system proceeds to step 611. A retrieved XML document is maintained in the cache and may cause one or more cached XML documents to be expunged from the cache. Step 609 may be performed prior to or during step 607 without departing from the present invention.

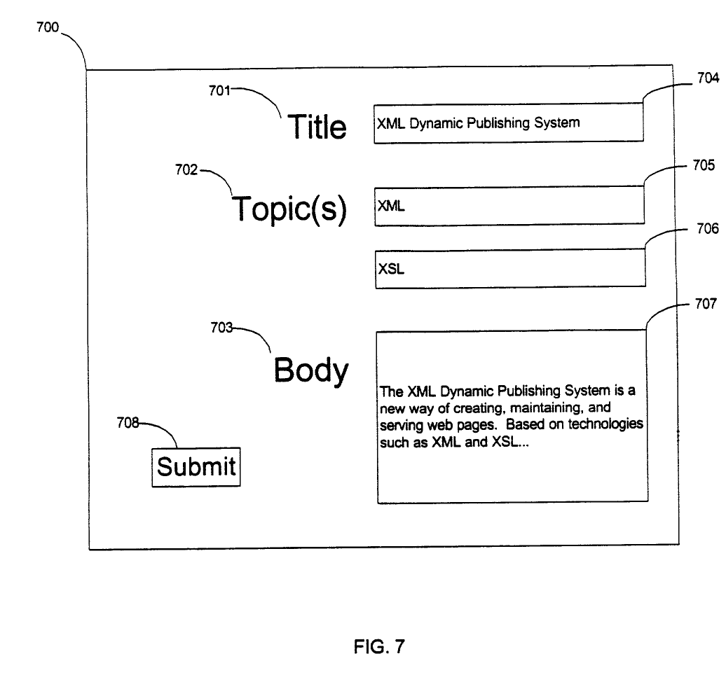

FIG. 7 is an example of a graphical user interface (GUI) for providing content to a content database 108 (shown in FIG. 1) by an author client. Upon authentication, GUI 700 is presented to an author client 104 (shown in FIG. 1). Labels 701-703 may identify the type of content that is to be entered in the associated text boxes 704-707. Labels 701-703 may be XML data type names. If the XML data type name is not sufficiently informative, another label may be used. Regardless of whether labels 701-703 are XML data type names, each of the associated data types is mapped to an XML data type. Accordingly, when submit button 708 is selected, the content of associated text boxes 704-707 is transmitted to the content database 108 along with the tags of the associated XML data type. For example, when submit button 708 is selected in FIG. 7, the text in text box 704 is submitted to the web server as “<TITLE>XML Dynamic Publishing System</TITLE>.” In this way, content providers submit XML-compliant content to a content database 108 via a browser. The labels, number of associated boxes, and associated XML data type for each of the associated boxes are determined by the administrator or other entity that creates the GUIs.

An author may select between a plurality of different GUIs based on the type of content the author intends to provide. Similarly, an author may update content within the author's authorization scheme in accordance with the present invention. In a preferred embodiment, any time that a document is updated, the cache is checked to determine whether either an XML document or an XHTML document based on the XML document are maintained therein. If either the updated XML document or an XHTML document based on the XML document are in cache, the document is updated and remains in cache or is deleted from cache without updating.

Other embodiments of the invention will be apparent to those skilled in the art from consideration of the specification and practice of the invention disclosed herein. The specification and examples should be considered exemplary only. The scope of the invention is only limited by the claims appended hereto.

What is claimed is:

1. A method for dynamically publishing a document in response to a request comprising the steps:
receiving a request for at least one element of content;
identifying at least one client capability attribute associated with the request;
selecting an XSL stylesheet based on the at least one client capability;
selecting a requested XML document based on the request;
merging the XML document and the selected XSL stylesheet to generate the document; and
transmitting the document.

2. The method of claim 1, wherein the request for at least one element of content comprises a request for a web page.

3. The method of claim 1, wherein the request for at least one element of content comprises a request for a dynamically generated web page.

4. The method of claim 1 comprising the further step:
caching the requested optimized document as a cached document, the selected XSL stylesheet as a cached XSL stylesheet and the requested XML document as a cached XML document.

5. The method of claim 4 comprising the further step:
selectively transmitting the cached document when a subsequently selected XSL stylesheet corresponds to the cached XSL stylesheet and a subsequently requested XML document corresponds to the cached XML document.

6. The method of claim 5 comprising the further step:
selectively selecting the cached XSL stylesheet if the cached XSL stylesheet corresponds to the subsequently selected XSL stylesheet.

7. The method of claim 5 comprising the further step:
selectively selecting the cached XML document if the cached XML document corresponds to the subsequently requested XML document.

8. The method of claim 7 comprising the further step:
selectively selecting the cached XSL stylesheet if the cached XSL stylesheet corresponds to the subsequently selected XSL stylesheet.

9. The method of claim 1, wherein the document is an XHTML document.

10. A publishing system for dynamically publishing a document comprising:
a styles sheet chooser that selects a stylesheet based on at least one capability associated with a requesting client;
a content agent that provides at least one element of content to a processor based on a received request;
a processor that accepts and merges the provided stylesheet and the provided content into the document; and
a transmission agent for transmitting the document to the requesting client.

11. The publishing system of claim 10, wherein the content agent selects a predetermined set of content from a database.

12. The publishing (claims 13-20 as well) system of claim 10 wherein the content agent dynamically generates sets of content from a database.

13. The system of claim 10 further comprising:
a cache, wherein the cache maintains a copy of previously transmitted documents as cached documents, previously selected stylesheets as cached stylesheets, and previously requested content as cached content.

14. The system of claim 13, wherein the cache selectively provides a cached document to the transmission agent if the cached document corresponds to the at least one capability associated with the client and the at least one element of content.

15. The system of claim 10, wherein the at least one capability associated with a requesting client is whether the client is a network appliance, a dial-up connected device or a high-speed networked device.

16. The system of claim 10, wherein the at least one capability associated with a requesting client is a browser type and a browser version.

17. The system of claim 10, wherein the at least one capability associated with a requesting client is a supported language capability that identifies the objects, methods and properties that the client can use.

18. The system of claim 10, wherein the at least one capability associated with a requesting client is an amount of bandwidth available to the client.

19. The system of claim 10, wherein the at least one capability associated with a requesting client is a set of physical properties associated with an output device associated with the client.

20. The system of claim 19, wherein the physical properties associated with the output device comprise a screen size, a screen resolution capability, and a screen color capability.
